(19) United States
(12) Patent Application Publication
(10) Pub. No.: US 2015/0363860 A1
(43) Pub. Date: Dec. 17, 2015

(54) SYSTEM AND METHODS FOR CONTINUOUSLY IDENTIFYING INDIVIDUAL FOOD PREFERENCES AND AUTOMATICALLY CREATING PERSONALIZED FOOD SERVICES

(71) Applicants: David Barron Lantrip, Ventura, CA (US); Mandana Mirabrishami, Ventura, CA (US); Nagabhushan Rao Machiraju, Ventura, CA (US)

(72) Inventors: David Barron Lantrip, Ventura, CA (US); Mandana Mirabrishami, Ventura, CA (US); Nagabhushan Rao Machiraju, Ventura, CA (US)

(21) Appl. No.: 14/302,436

(22) Filed: Jun. 12, 2014

(51) Int. Cl. G06Q 30/06; G06Q 10/02; G06Q 20/02

(52) U.S. Cl. CPC G06Q 30/0631; G06Q 20/02; G06Q 30/0623; G06Q 10/02; G06Q 50/12

(57) ABSTRACT

A system and methods for continuously identifying individual food preferences and automatically creating personalized food services are disclosed. The system includes a data collection unit configured to collect, extract and structure raw data of user from a multiplicity of information sources. The system further includes a data processing and analytics unit comprising a multiplicity of specialized units configured to identify one or more user preferences and create preferable products for the user based on the structured data provided by the data collection unit; as well as user interface, presentation, and device access units configured to optimize a layout of application-specific information and user interfaces for specific types of web-enabled devices of the user.

### TECHNICAL FIELD

The disclosed subject matter relates generally to the field of providing personalized services, and more particularly to a system and method for continuously identifying individual food preferences and automatically creating real-time and dynamic personalized food services.

### BACKGROUND

Rapid strides in technology are enabling increasingly personalized products and services. These developments offer an opportunity to create personalized food offerings to suit each individual's dietary preferences.

In order to create personalized food offerings it is necessary to continuously understand the eating habits, social habits, ethnic and regional preferences, ingredient preferences, and special health-related dietary requirements of the individuals. It is also necessary to apply this understanding to creating and serving food items that will satisfy the preferences and dietary requirements of individuals whenever and wherever they are required.

In the light of aforementioned discussion, it is essential to identify individual food preferences and automatically create personalized food services.

### BRIEF SUMMARY

The following presents a simplified summary of the disclosure in order to provide a basic understanding to the reader. This summary is not an extensive overview of the disclosure and it does not identify key/critical elements of the invention or delineate the scope of the invention. Its sole purpose is to present some concepts disclosed herein in a simplified form as a prelude to the more detailed description that is presented later.

For purposes of summarizing, certain aspects, advantages, and novel features are described herein. It is to be understood that not all such advantages may be achieved in accordance with any one particular embodiment. Thus, the disclosed subject matter may be embodied or carried out in a manner that achieves or optimizes one advantage or group of advantages without achieving all advantages as may be described or suggested herein.

Exemplary embodiments of the present disclosure are directed towards a system and methods for continuously identifying individual food preferences and automatically creating personalized food services.

An exemplary preferred aspect of the present disclosure is to provide a variety of food service offerings at multiple food establishments which refer to including, though not limited to, restaurants, drive through fast food locations, hospital meals, meals in train or airline, homes, assisted living facilities, universities and schools, corporate and event catering, grocery providers, and other personalized meal delivery offerings and food offered from dispensing machines.

An exemplary preferred aspect of the present disclosure is to continuously capture user's food and other preferences and requirements to enable creating a unique user preferences profile. A variety of methods may be used to capture user food preferences and requirements including, though not limited to, (a) user specified preferences through entries in paper and/or electronic surveys, including medical restrictions such as allergies and special dietary requirements, (b) suggested through communications from the user through various means (feedback), (c) identified through analysis of orders placed by the user from electronic menus, (d) identified through analysis of online food ratings (e) identified through changes to the user's reported quantities of consumption of certain foods, (f) suggested by changes to the user's reported health status, (g) identified through analysis of online social networking shares and comments, (h) suggested by analysis of travel patterns that may indicate new food interests, without limiting the scope of the disclosure.

An exemplary preferred aspect of the present disclosure is to compile and update the user food preferences profile over time—before ordering, during ordering, and after ordering, in a continuous and dynamic process using the methods described above.

An exemplary preferred aspect of the present disclosure is to create and continuously refine a food preferences predictive model for the user based on weights assigned to the elements of the food preferences profile. The predictive model may enable suggesting menu items that are more likely to satisfy the user's changing food and other preferences and dietary requirements.

An exemplary preferred aspect of the present disclosure is the use of the predictive model to rank a unique menu of food items for each user according to how likely the user will be to order them.

An exemplary preferred aspect of the present disclosure is to enable the user to view the personalized recipes (and constituent ingredients) used to prepare all menu items that satisfy the user's food preferences and dietary requirements prior to ordering or at any time.

An exemplary preferred aspect of the present disclosure is to compute the detailed nutritional values of all menu items and enable the user to view this information prior to ordering or at any time.

An exemplary preferred aspect of the present disclosure is to provide a personalized food preferences profile that can be carried by the user as a profile card or other electronic media. The profile card and electronic profile media will provide value for the user including, but not limited to (a) access to personalized food services from any participating 3^{rd} party food service vendor or food dispensing machine, including ordering for immediate consumption as well as ordering for delivery where available (b) cashless payment for these and other services (c) assurances that the food will be prepared by participating vendors according to the preferences and restrictions specified by the personalized food preferences profile (d) logging of all food ordered, regardless of the location, and (e) complete nutritional analysis of all food ordered for any desired period.

An exemplary preferred aspect of the present disclosure is to enable web-enabled devices to use the personalized food preferences profile to algorithmically match the user to proximate food establishments that best fit the user's preferences and, for participating establishments, enable the user to order from a personalized menu.

An exemplary preferred aspect of the present disclosure is to enable personalization of the food offerings for the user by providing web access to the personalized food preferences profile of the user to authorized food service vendors and authenticated food dispensing machines.

An exemplary preferred aspect of the present disclosure is to enable the user to review and modify the user's food preferences profile through any web-enabled device including, but not limited to, kiosks connected to a data communication network, web-enabled device operating in a data communication network, and other user wearable/handheld devices, and any other interactive device through an authenticated cloud access.

An exemplary preferred aspect of the present disclosure is to enable the user to securely review all account activity through any web-enabled device, including personal food purchase history and all associated nutritional information, consumption and health logs, food ratings, recipe submissions, and other feedback information.

An exemplary preferred aspect of the present disclosure is to offer the user access via the web-enabled device to a personalized menu of food items that are available for order through a variety of means, including most proximate food service vendors.

A more complete appreciation of the present disclosure and the scope thereof can be obtained from the accompanying drawings which are briefly summarized below and the following detailed description of the presently preferred embodiments.

### BRIEF DESCRIPTION OF THE DRAWINGS

Other objects and advantages of the present disclosure will become apparent to those skilled in the art upon reading the following detailed description of the preferred embodiments, in conjunction with the accompanying drawings, wherein like reference numerals have been used to designate like elements, and wherein:

FIG. 1 is a block diagram depicting a system for identifying individual food preferences and creating personalized food services.

FIG. 2 is a flow diagram depicting exemplary embodiments for identifying individual food preferences to create personalized food services across a multiplicity of delivery methods.

FIG. 3 is a flow diagram depicting a more specific instance of the method suitable for restaurant or other food service establishment applications, in accordance with exemplary embodiment of the present disclosure.

FIG. 4 is a flow diagram depicting methods of order process, in accordance with exemplary embodiment of the present disclosure.

FIG. 5 is a flow diagram depicting methods of preparation and service process, in accordance with exemplary embodiment of the present disclosure.

FIG. 6 is a flow diagram depicting in-home personalized mealcare delivery application, in accordance with exemplary embodiment of the present disclosure.

### DESCRIPTION

It is to be understood that the present disclosure is not limited in its application to the details of construction and the arrangement of components set forth in the following description or illustrated in the drawings. The present disclosure is capable of other embodiments and of being practiced or of being carried out in various ways. Also, it is to be understood that the phraseology and terminology used herein is for the purpose of description and should not be regarded as limiting.

The use of “including”, “comprising” or “having” and variations thereof herein is meant to encompass the items listed thereafter and equivalents thereof as well as additional items. The terms “a” and “an” herein do not denote a limitation of quantity, but rather denote the presence of at least one of the referenced item. Further, the use of terms “first”, “second”, and “third”, and the like, herein do not denote any order, quantity, or importance, but rather are used to distinguish one element from another.

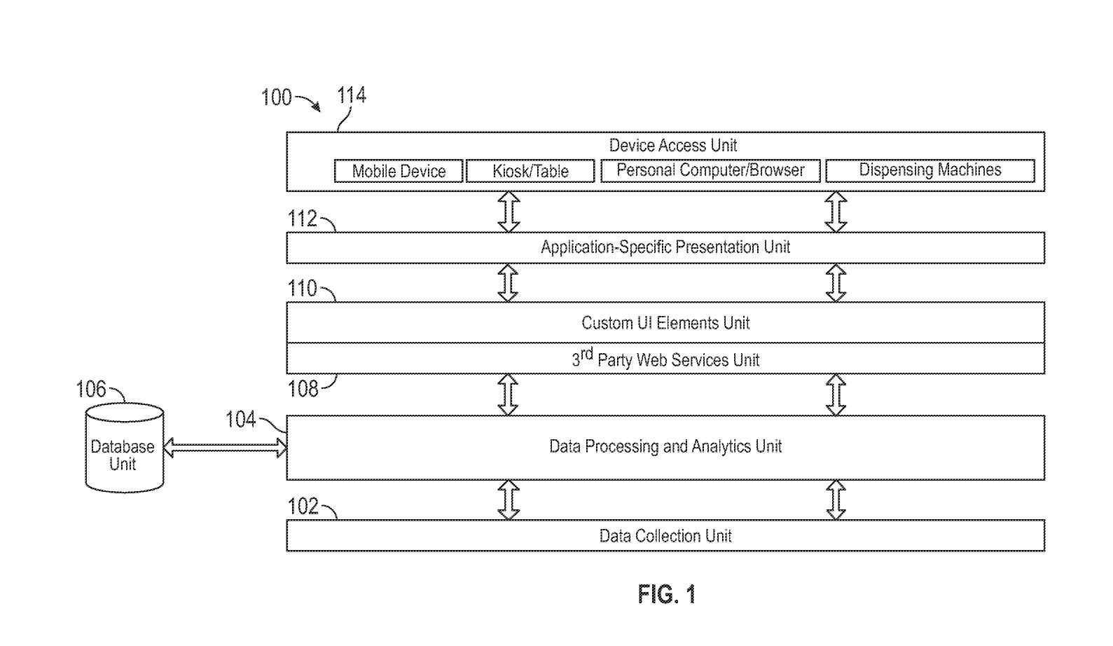

FIG. 1 illustrates a block diagram 100 of a system for identifying individual food preferences and creating personalized food services. As shown in FIG. 1, a data collection unit 102 may be configured to collect raw data of users from a multiplicity of information sources. In accordance with the present disclosure, the multiplicity of information resources here may refer to, but are not limited to, user preferences, food associated survey responses of user, interactive feedback of the user for the food (e.g., meal ratings), social network shares, food orders, food consumption feedback, recipe submissions, voting and the like. The data collection unit 102 may be configured to extract the information for identifying the user preferences and requirements. The collected data may be structured by the data collection unit 102 for identifying the user preferences.

As shown in FIG. 1, the data collection unit 102 further communicates with a data processing and analytics unit 104. The data processing and analytics unit 104 may be configured to process the structured data for creating preferable products of the user. The preferable products may include, but not be limited to, the personal food preferences profile, personalized menu, menu item details, items list for ordering and paying, payment options, food preparation instructions, supply chain invoices, user communications, nutritional reports, social media options, and the like. The data processing and analytics unit 104 creates the preferable products of the user through a multiplicity of specialized data processing units which may include, but are not limited to, account and profile manager unit, menu generator unit, item detail page generator unit, select and order unit, payment manager unit, order manager unit, preparation display generator unit, service manager, supply chain manager unit, feedback manager unit, report unit, social unit, recipe manager unit and the like. The data from the data processing and analytics unit may be stored in a database unit 106.

In some exemplary embodiments, a third party web services unit 108 which may include open source or third party tools known in the art or future implemented for authenticating user logins, making table reservations, providing directions through geographic information system (GIS) mapping, making payments, updating nutritional data, and business accounting.

A custom user interface (UI) elements unit 110 may include specially designed user interfaces to make it easy for the user to access features from third party tools as well as proprietary features, such as the personalized menu with details and ordering functions, order tracking, reports, entertainment and business tools.

An application-specific presentation unit 112 may be configured to display and reveal the features required for a specific application. The specific applications here may refer to, general restaurant food service, airline service, in-home meal delivery and the like, without limit the scope of the disclosure.

As shown in FIG. 1, a device access unit 114 may be configured to optimize the layout of application-specific information and user interface for specific types of devices, such as mobile, kiosk, PC/browser, various food dispensing systems.

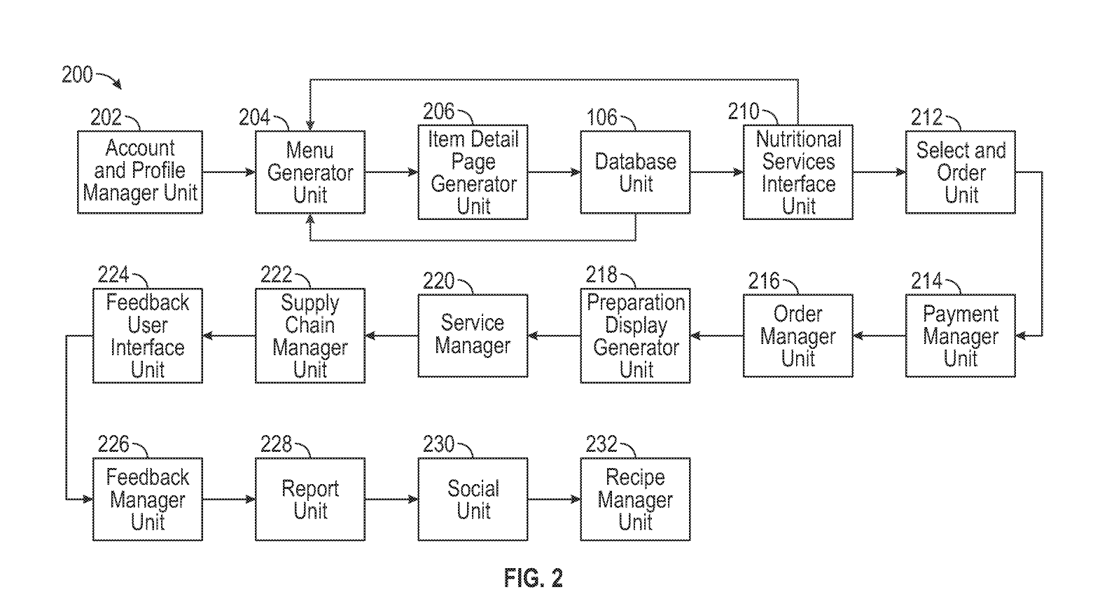

Referring to FIG. 2 is a flow diagram 200 illustrating an exemplary embodiment for identifying individual food preferences to create personalized food services across a multiplicity of delivery methods. The embodiments shown in FIG. 2 are connected through a network. The network here may refer to any type of network known in the art or future developed. In this regard the network may be a local area network or wide area network, e.g., the Internet, or combination of networks. The account and profile manger unit 202 enables a user to create a user account by providing personal details. The personal details of the user may include, but not limited to, a user name, address, email-id, mobile number, password and the like. The created user account may be used to login into an authorized application platform through a web-enabled device. The web-enabled device may include, but not limited to, mobiles, laptops, handheld computers, tablet computers, personal computers, personal Digital Assistants (PDAs), network PCs, wearable computers and the like. Then the account and profile manger unit 202 may create a user personal preferences profile based on the personal details and preferences provided by the user. The account details and user personal preferences profile may also be edited or updated by the user at any time. Further the account and profile manger unit 202 stores payment information of the user to enable cashless service with any authorized business and authenticate login attempts.

As shown in FIG. 2, the user may be enabled to create a personalized menu of meals based on personal preferences and dietary restrictions by using a menu generator unit 204. In response, an electronic menu may be provided to the user with multiple options to modify the personalized menu of meals for selecting and ordering preferred food items. An item detail page generator unit 206 provides an awareness of detailed information relating to every food item(s) including, but not limited to, complete nutrition data, sources of ingredient micro-nutrients, and preparation methods to the user in response to the request, without limiting the scope of the disclosure. The user personalized data stored in the database unit 106 may be identified.

As shown in FIG. 2, a nutritional services interface unit 210 may be configured to enable the user to access professional nutritionist services to address the user's special dietary requirements. Subsequently the user receives an appropriate diet plan for any special medical conditions from the nutritionist. A select and order unit 212 enables the user to select and order any food item from the electronic menu through the web-enabled device of the user. A payment manager unit 214 may be configured to provide a payment page to the user for paying for services and the amount for the ordered food items using stored user account information, credit card, debit card and the like. The payment page may also display other display options provided by the payment manager unit 214 including, but not limited to, expected delivery time, loyalty credits and the like. The user may use the web-enabled device to make the payment. The payment manager unit 214 allows the user to make the payments using the payment methods known in the art or future implemented payment methods.

Further as shown in FIG. 2, an order manager unit 216 may be configured to route the meal orders which are made from the electronic menu (at the select order unit 212) to the most proximate meal preparation and a delivery center. The meal preparation and delivery center may include, but not be limited to, a kitchen of a restaurant, regional preparation center and the like. Each ordered meal is queued for preparation at the appropriate time to ensure the best possible taste and nutritional qualities of the delivered meals. Some meals will be delivered hot and some will be delivered chilled or frozen for later warming depending on the requirement. The user can electronically track the progress of each meal/package of food from time of order to time of service/delivery. Further a preparation display generator unit 218 may be configured to display the preparation information when an order is queued up for preparation, including personalized instructions, preparation timer and completion button to pass the order for delivery.

As shown in FIG. 2, when the order is ready, a service manager unit 220 first verifies if the order is to be served to a table or should be passed to a take-out or to a drive-through customer window, or should be delivered to an address. For table service, the service manager unit alerts a runner and queues up the order for delivering the food. When delivered, the food is delivered through specially equipped trucks to each destination such as home, office, or other location within the region, without limiting the scope of the disclosure.

Further as shown in FIG. 2, a supply chain manager unit 222 may be configured to keep track of ingredient inventories and assures their restocking in time for next use. All ingredients may be coded, tagged and logged into the database unit 106 when delivered by a supplier. Thereafter the preparation of specific recipes will automatically decrement the quantity tracked by the supply chain manager unit 222, which will then alert managers to low stocks and automatically prepare resupply orders for ingredients suppliers.

As shown in FIG. 2, a feedback user interface unit 224 may be configured for enabling the user to log food amounts consumed and food feedback data. The user may use any web-enabled device and an online form to log or record how much of each meal item was eaten and levels of satisfaction with meals. This makes it possible to produce accurate nutritional reports that detail the macro- and micro-nutrients being consumed daily, weekly, and monthly. This data will be critical to correlate user weight/health changes with diet and to make adjustments to the menu items as needed to support optimal health and satisfaction with the service.

Further as shown in FIG. 2, a feedback manager unit 226 may collect feedback data from the user and automatically process and associate the data with the user's account. The feedback data may include, but is not limited to, structured form data, unstructured text comments and the like. A report unit 228 may collect the food consumption data of the user from the feedback manager to create reports. The reports may include summarized order history, nutritional intake, food ratings and food feedback data and the like without limiting the scope of the disclosure. The nutritional reports are generated based on the complete history of orders, payments, nutritional intake, food ratings (favorites), comments, or any other information submitted by the user or otherwise collected.

As shown in FIG. 2, a social unit 230 may enable the user to share favorite foods, ratings, recipes, and comments with others through social networks. The social networks may refer to the social networks known in the art (e.g., Facebook, Google Plus) or future implemented. A recipe manager unit 230 enables the user to submit recipes of favorite foods. The food recipes submitted by the users using a recipe manager interface to any web-enabled device. The recipes may also be analyzed to identify ingredients that need to be added to the user's personal profile and/or given more weight in creating future menu items. A recipe manager unit 232 may provide polling functions to allow all users to rate their favorite recipe submissions, thereby enabling the recipe manager to identify potential new recipes items for food service establishments.

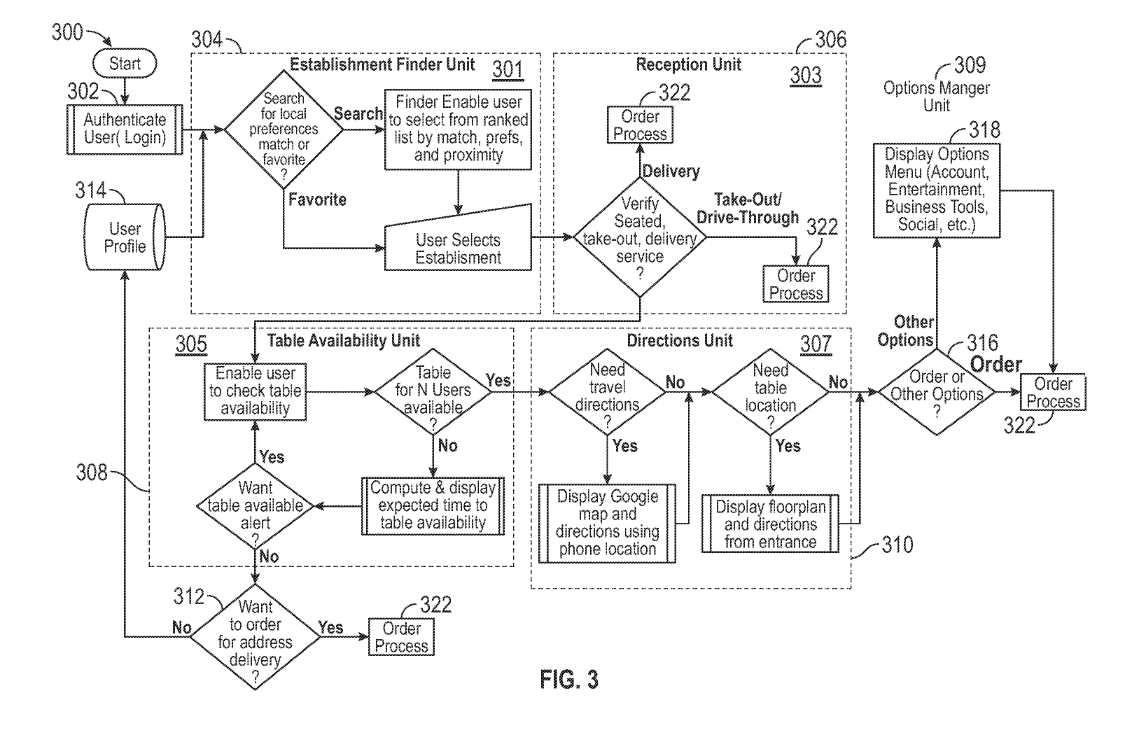

FIG. 3 is a flow diagram 300 illustrating a more specific instance of a method suitable for restaurant or other food service establishment applications, in accordance with preferred embodiments of the present disclosure. The embodiments shown in FIG. 3 are connected through a network. The network here may refer to any type of network known in the art or future developed. In this regard, the network may be a local area network or wide area network, e.g., the Internet, or combination of networks. The method 300 for accomplishing restaurant or other food service establishment applications includes a multiplicity of specialized units such as an establishment finder unit 301, a reception unit 303, a table availability unit 305, a directions unit 307, and an options manager unit 309. The method starts at step 302, wherein an account and profile manager unit 202 (shown in FIG. 2) may be configured to create a user personal preferences profile based on the personal details and preferences provided by the user. Then the user is enabled to login with an authorized application platform. At step 304, the establishment finder unit 301 may search for proximate food service establishments which satisfy the user's personal preferences and ranks a list of food service establishments according to strength of match, availability of personalized menu service and proximity.

In accordance with a non limiting exemplary embodiment of the present disclosure, the ranked list or favorites list may be transmitted to the reception unit 303 at step 306. The user may select required service such as seated service in food service establishment, take-out service, and delivery service. If the user desires seated service in a food service establishment, the reception unit 303 passes control to the table availability unit 305 and if the user desires take-out service or delivery service the reception unit 303 passes control to an order process 322.

At step 308, the table availability module 305 enables the user to check the availability of a table in a desired food service establishment and also specify how many users will be seated at the desired table. If the required user table is not available, the table availability unit 305 computes and displays the expected time to table availability and provides the option for a table availability alert to the user. Once the table availability has been confirmed, then the directions unit 307 verifies if the user needs travel directions from current global positioning system (GPS) location and if yes, a map is generated and step-by-step directions for the route may be displayed on the user's web-enabled device. The directions unit 307 also verifies if the user would like to see the location of the table on the establishment's floor plan and provides if requested at step 310.

Further as shown in FIG. 3, if a required table is not available and the user is not interested in receiving the table alert, the process continues by verifying whether or not the user is interested to have home delivery for food at step 312. If the user is interested in receiving home delivery, then the process continues with the order process 322 by displaying a welcome screen on the web-enabled device. If the user is not interested in receiving home delivery service, the process continues by updating the user profile in the database at step 314.

As shown in FIG. 3, at step 316 the user may order or view other options. If other options are selected, then at step 318 the options manager unit 309 presents several feature options to the user, including, but not limited to, view and update user account information, use cloud-based business tools, link to social network interfaces, or interact with various entertainment options. The user may choose to order food items at any time at step 322.

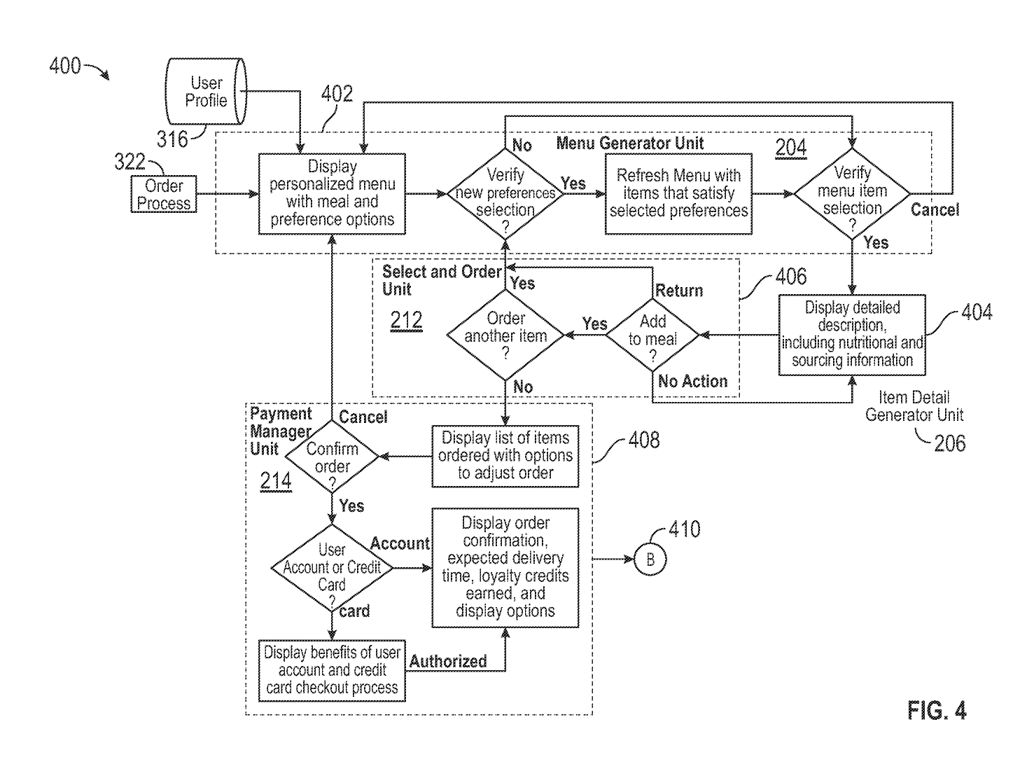

FIG. 4 is a flow diagram 400 illustrating methods of order process. An exemplary aspect of the present disclosure, the method starts at step 402 wherein a menu generator unit 204 displays a welcome screen and unique menu to the user that is created based on the user's personal food preferences profile, as stored in the database unit 106, and any current choice of food options. At step 404 the user may be enabled to select any menu item and view more information using an item detail generator unit 206. The item detail page generator unit 206 compiles and displays detailed recipe, micro-nutrient and source information on request by the user. Qualities of ingredients may also be indicated, such as locally grown, organic, etc. and displays the preparation methods of food items.

As shown in FIG. 4, the select and order unit 212 allows the user to either order the menu item or return to the menu at step 406. The select and order unit 212 enables the user to order meals from the electronic menu on any web-enabled device. When the order is finished by the user, the control is passed to a payment manager unit 214 for processing the payments of the user at step 408. The payment manager unit 214 displays a payment page when one or more menu items are selected for ordering by using select and order unit 212, and enables the user to use a credit card or authenticate and pay using financial information stored in the user's account. At last step 410, when the payment process is completed, the order passes to a preparation and service process.

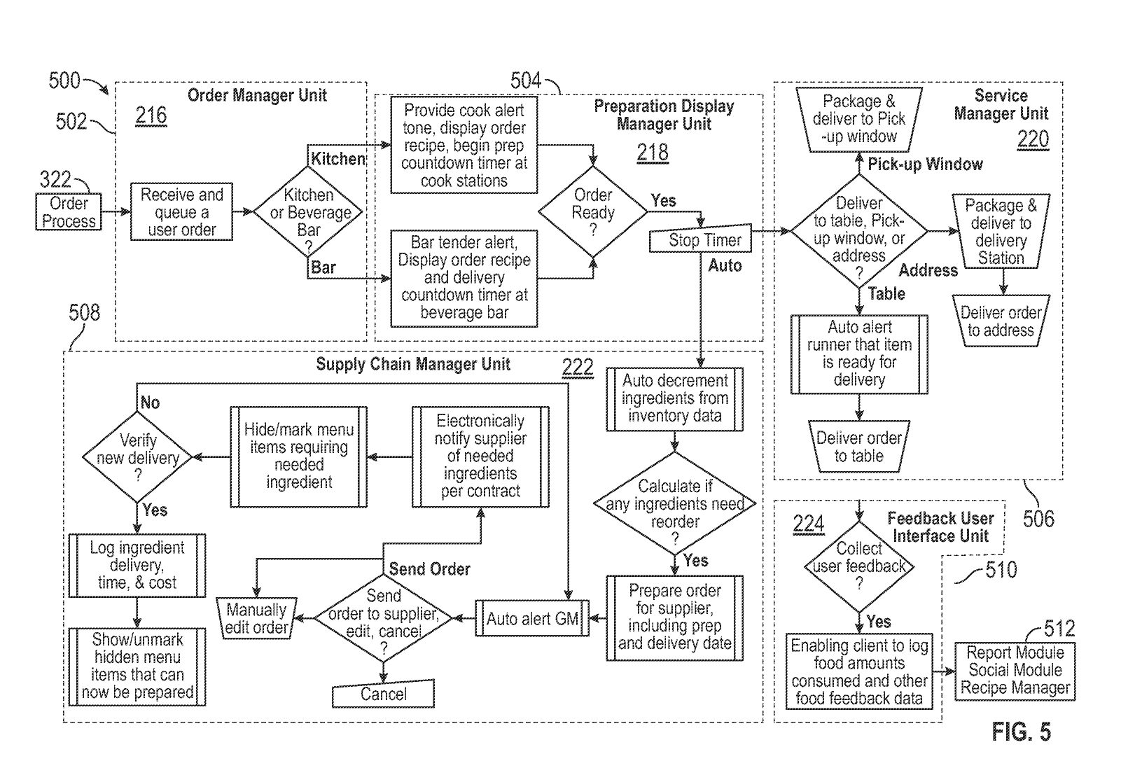

FIG. 5, is a flow diagram 500 illustrating methods of preparation and service process. The method starts at step 502, wherein an order manager unit 216 routes orders made from the electronic menu. The orders are displayed by using a preparation display manager unit 218 in either the kitchen or the beverage bar at step 504. The preparation display manager unit 218 provides a cook alert tone to begin preparation countdown timer at cook stations and also provide bar tender alert to begin delivery countdown timer at beverage bars. When the order is ready, a service manager unit 220 first verifies if the order is to be served to a table, passed to a take-out or drive-through customer window, or delivered to an address. If for table service, the service manager method alerts a runner and queues up the order for delivery at step 506.

Further at step 508, a supply chain manager unit 222 verifies the ingredients used in each order in all cases and keeps track of ingredient inventories and assures their restocking in time for next use. All ingredients are coded, tagged and logged into the supply chain manager when delivered by a supplier. Thereafter the preparation of specific recipes will automatically decrement the quantity tracked by the supply chain manager unit 222, which will then both alert managers to low stocks and automatically prepare resupply orders for ingredients suppliers. If the ingredients are depleted before resupply, then the menu items requiring the ingredients are temporarily hidden from view or otherwise annotated so that a user cannot order a menu item when there are insufficient ingredients to prepare it. Delivery of new ingredients is verified and associated menu items are reactivated.

At step 510 a feedback user interface unit 224 enables a user to use any web-enabled device and an online form to record how much of each meal item was eaten and levels of satisfaction with meals. This makes it possible to produce accurate nutritional reports that detail the macro- and micro-nutrients being consumed, as well as allow the user to make adjustments to the menu items as needed to support optimal health and satisfaction with the service. Further at step 512, the control is next passed to a report unit, social unit and recipe manager as described previously.

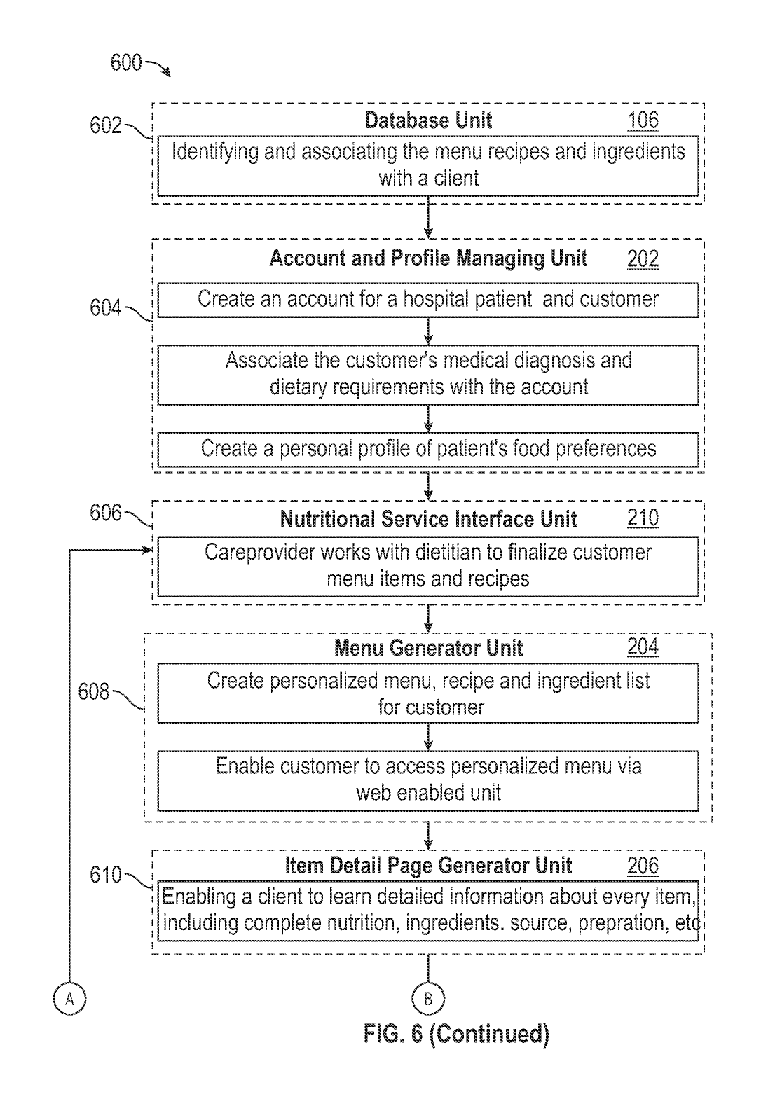

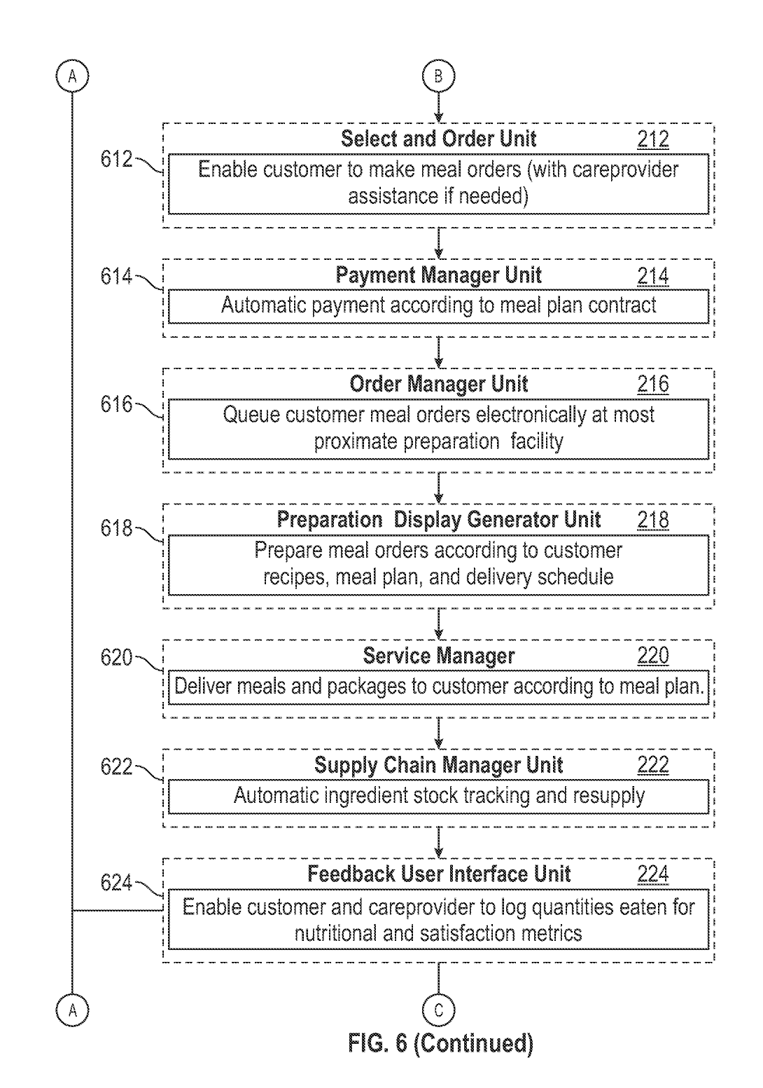

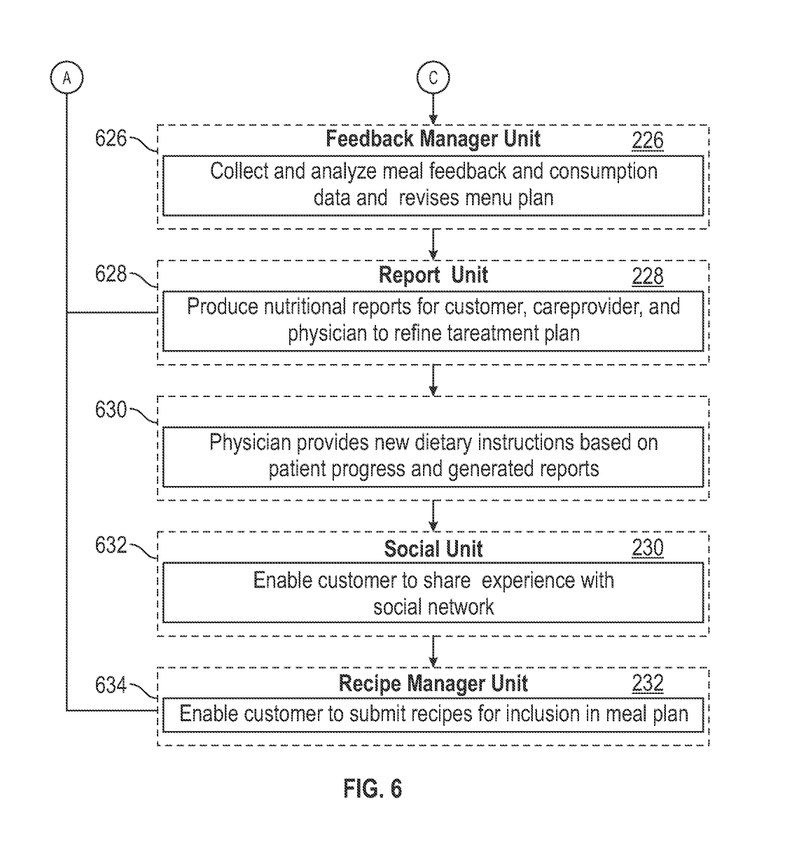

FIG. 6 is a flow diagram 600 depicting the method for in-home personalized meal care delivery application. The method starts at step 602, wherein the database unit 106 is used for identifying and associating the menu recipes and ingredients with the user. Then an account and profile manager unit 202 enables creating an account for a hospital patient (user) by providing patient personal details at step 604. The personal profile of patient is then created with food preferences and health-related data updated by the patient or care provider. A nutritional service interface unit 210 enables the care provider to access professional nutritionist services to address the patient's special dietary requirements and to finalize patient's personal menu items and recipes based on the advice of the nutritionist at step 606. At step 608, a menu generator unit 204 creates a personalized menu with recipes, ingredient list to the finalized menu and enables the user to access personalized menu through a web-enabled device from home. An item detail page generator unit 206 provides awareness of detailed information about every food item including complete nutrition, sources of ingredients, micro-nutrient, and preparation methods of personalized food items at step 610.

At step 612, the select and order unit 212 enables the user or care provider to select and order any food item from the electronic personalized menu through the web-enabled device. Then a payment manager unit 214 provides a payment page for paying the amount to the ordered food items using stored account information, credit card, debit card and the like, without limiting the scope of the disclosure at step 614. The payment information of the user may be securely stored in the user's account. An order manager 216 may route the meal orders which are made from the electronic menu to the most proximate meal preparation and a delivery center at step 616. Further at step 618, a preparation display generator unit 218 may be configured to display the preparation information when an order is queued up for preparation, including personalized instructions and schedule for delivering the food.

Further as shown in FIG. 6, the service manager delivers the prepared meals and food packages to the user according to the meal plan at step 620. Next at step 622, a supply chain manager unit 222 keeps track of ingredient inventories and assures their restocking in time for next use. A feedback user interface unit 224 enables the user or care provider to use any web-enabled device and an on-line form to record how much of each meal item was eaten and levels of satisfaction with meals at step 624. This makes it possible to produce accurate nutritional reports that detail the macro- and micro-nutrients being consumed daily, weekly, and monthly. This data will be critical to correlate user weight/health changes with diet and to make adjustments to the menu items as needed to support optimal health and satisfaction with the service.

In accordance with a non limiting exemplary embodiment of the present disclosure, at step 626, a feedback manager unit 226 collects feedback data from the user and automatically processes and associates the data with the user's account. Further at step 628, a report unit 228 collects the food consumption data of the user from the feedback manager unit 226 to produce nutritional reports that enable the treatment plan to be refined. The physician may provide new dietary instructions based on user (patient) progress and meal care reports at step 630. Then the user may share experience with a social network by using a social unit 230 at step 632. Further at step 634, the user is enabled to submit recipes for inclusion in the meal plan by a recipe manager unit 232. Last at step 634, the food plan may be transmitted to a nutritional service interface unit for further process as described previously; and the meal plan, patient treatment plan, nutritional and satisfaction matrices further transmitted to the nutritional service interface to update the user menu items and recipes.

The claimed subject matter has been provided here with reference to one or more features or embodiments. Those skilled in the art will recognize and appreciate that, despite of the detailed nature of the exemplary embodiments provided here; changes and modifications may be applied to said embodiments without limiting or departing from the generally intended scope. These and various other adaptations and combinations of the embodiments provided here are within the scope of the disclosed subject matter as defined by the claims and their full set of equivalents.

1. A system comprising:
a data collection unit configured to collect raw data of a user from a multiplicity of information sources of the user, whereby the collected data is used to identify one or more user preferences for creating a preferences profile of the user;
a data processing and analytics unit configured to create preferable products for the user based on the structured data provided by the data collection unit; and
a device access unit configured to optimize a layout of application-specific information and user interface for a specific types of web-enabled devices of the user.

2. The system of claim 1, wherein a third party web services unit is configured to provide third party tools for at least one of: authenticating the user; making table reservations; providing directions through geographic information system (GIS) mapping; making payments; updating nutritional data; and business accounting.

3. The system of claim 2, wherein a custom user interface unit is configured to provide user interfaces to access the third party tools from the third party web services unit.

4. The system of claim 3, wherein an application specific presentation unit is configured to display custom user interface unit features for a specific application.

5. The system of claim 1, wherein the data processing and analytics unit comprises an account and profile manager unit configured to enable the user to create a user account by providing a plurality of personal details.

6. The system of claim 1, wherein an account and profile manager unit is configured to authenticate the user logins with account information.

7. The system of claim 1, wherein the data processing and analytics unit comprises a menu generator unit configured to create a personalized menu of meals based on a plurality of personal preferences and dietary restrictions of the user.

8. The system of claim 1, wherein the data processing and analytics unit comprises an item detail page generator unit configured to provide information relating to a plurality of food items.

9. The system of claim 1, wherein the data processing and analytics unit comprises a nutritional services interface unit configured to enable the user to access professional nutritionist services to address the user's special dietary requirements.

10. The system of claim 1, wherein the data processing and analytics unit comprises a select and order unit configured to enable the user to select and order at least one food item from an electronic menu through a web-enabled device of the user.

11. The system of claim 1, wherein the data processing and analytics unit further comprises a payment manager unit configured to provide a payment page to the user on the web-enabled device for paying the amount for the ordered food items.

12. The system of claim 1, wherein the data processing and analytics unit comprises an order manager unit configured to route the meal orders from the electronic menu to a proximate meal preparation and delivery centre and optimally queue the orders for preparation.

13. The system of claim 1, wherein the data processing and analytics unit further comprises a preparation display generator unit configured to display the preparation information of an ordered meal at the meal preparation centre for preparation personnel.

14. The system of claim 1, wherein the data processing and analytics unit comprises a service manager unit configured to deliver the prepared meals and ordered food packages to the user.

15. The system of claim 1, wherein the data processing and analytics unit further comprises a supply chain manager unit configured to track at least one of: ingredient inventories; issue ingredient resupply alerts; and prepare orders for ingredients suppliers.

16. The system of claim 1, wherein the data processing and analytics unit comprises a feedback user interface unit configured to enable the user to log food amounts consumed and food feedback data.

17. The system of claim 1, wherein the data processing and analytics unit comprises a feedback manager unit configured to collect the feedback data from the user and automatically process and associate the data with the user's account.

18. The system of claim 1, wherein the data processing and analytics unit comprises a report unit configured to collect food consumption data of the user from the feedback manager unit to create reports.

19. The system of claim 1, wherein the data processing and analytics unit comprises a social unit configured to enable the user to share information through a plurality of social networks.

20. The system of claim 1, wherein the data processing and analytics unit further comprises a recipe manager unit configured to enable the user to submit one or more recipes through the web-enabled device of the user.

21. The system of claim 1, wherein an establishment finder is configured to search for proximate food service establishments which satisfy the user's personal preferences and ranks a list of food service establishments.

22. The system of claim 1, wherein a reception module enables the user to select required service comprises at least one of: a seated service at the food service establishment; a take-out service; and a delivery service.

23. The system of claim 1, wherein a table availability unit is configured to provide seated service availability to the user.

24. The system of claim 1, wherein a directions unit is configured to provide travel directions to the food service establishment to the user.

25. The system of claim 1, wherein an options manager unit is configured to provide a plurality of options required to the user.

26. A method, comprising:
creating a personal profile of a user based on a plurality of personal details and a plurality of preferences of the user by an account and profile manage unit;
providing details of proximate food service establishments based on personal profile of the user by an establishment finder unit; and
enabling the user to select a required service in the food establishments by a reception unit

27. The method of claim 26 comprises a step of enabling the user to check an availability of a suitable table in the food service establishment by a table availability unit.

28. The method of claim 26 comprises a step of providing direction to a location of the food service establishment to the user by a directions unit.

29. The method of claim 26 comprises a step of providing direction to a location of the reserved table in a food service establishment to the user by a directions unit.

30. The method of claim 26 further comprises a step of providing a table alert to the user by a table availability unit.

31. The method of claim 26 comprises a step of displaying an options menu on the web-enabled device of the user or updating and selecting the required service options by an options manager unit.

32. A method comprising:
enabling a user to order personalized meals using an electronic menu displayed on a web-enabled device by a select and order unit;
displaying a payment page for enabling the user to pay for ordered meals by a payment manager unit; and
passing a control to process order for delivering the ordered food to the user;

33. The method of claim 32 comprises a step of displaying a screen with personalized menu on the web-enabled device of the user by a menu generator unit.

34. The method of claim 32 comprises a step that enables the user to select preference options and filter the menu by a menu generator unit.

35. The method of claim 32 comprises a step that enables the user to view information by selecting a food item provided in the personalized menu by an item detail generator unit.

36. The method of claim 32 comprises a step of compiling and displaying detailed recipes information and preparation method by an item detail page generator unit.

37. The method of claim 32 comprises a step enabling the user to select and order one or more items on the personalized menu by a select and order unit.

38. The method of claim 32, wherein a payment page lists items to be ordered and enables the user to edit the order list by a payment manager unit.

39. The method of claim 38, wherein a payment page enables a user to pay for an order using a payment manager unit.

40. The method of claim 38, wherein a payment page confirms payment for ordered items and displays display options of the payment manager unit.

41. A method comprising:
receiving and queuing a user order by an order manager unit;
displaying a preparation process of ordered food by a preparation display manager unit; and
serving the ordered food by a service manager based on the preferable service selected by the user.

42. The method of claim 41 comprises a step of receiving an order made from a web-enabled user device of the user and optimally queuing the order for preparation by an order manager unit.

43. The method of claim 41 comprises a step of routing the prepared meal for at least one of: a delivery to table; a pick-up window; and address provided by a service manager unit.

44. The method of claim 41 comprises a step of tracking the ingredients required for preparing the ordered meal to alert ingredient inventories and ingredient suppliers by a supply chain manager unit.

45. The method of claim 41 comprises a step of enabling the user to provide food consumption logs and qualitative feedback by a feedback user interface unit.
